(19) United States
(12) Patent Application Publication
(10) Pub. No.: US 2020/0130158 A1
(43) Pub. Date: Apr. 30, 2020

(54) SETTING TOOL

(71) Applicant: fischerwerke GmbH & Co. KG, Waldachtal (DE)

(72) Inventors: Georg BACHMAIER, Munich (DE); Patrick FRÖSE, Munich (DE); Matthias GERLICH, Munich (DE); Wolfgang ZÖLS, Munich-Lochhausen (DE); Marco CYRIACKS, Munich (DE); Gerit EBELSBERGER, Munich (DE); Randolf MOCK, Hohenbrunn (DE); Reinhard FREITAG, Munich (DE)

(21) Appl. No.: 16/607,358

(22) PCT Filed: Apr. 20, 2018
(86) PCT No.: PCT/EP2018/060187

§ 371 Date: Oct. 22, 2019

(30) Foreign Application Priority Data
May 5, 2017 (DE) 10 2017 207 625.9
May 5, 2017 (DE) 10 2017 207 628.3
May 5, 2017 (DE) 10 2017 207 630.5
Oct. 23, 2017 (DE) 10 2017 218 871.5
Apr. 9, 2018 (DE) 10 2018 108 280.0

(51) Int. Cl. B25C 1/06; B25C 1/04

(52) U.S. Cl. CPC B25C 1/06; B25C 1/047

(57) ABSTRACT

A setting tool having a drive apparatus, having a rod-shaped plunger for driving in a fixing means, a tubular rotary body, at least one spring element, first winding cords which connect the spring element and the rotary body and which convert a linear movement of the spring element into a rotational movement of the rotary body, and second winding cords which connect the rotary body and the plunger and which convert a rotational movement of the rotary body into a linear movement of the plunger.

### FIELD OF THE INVENTION

The invention relates to a setting tool for setting fixing means, especially nails, in a substrate, especially made of concrete.

### BACKGROUND OF THE INVENTION

For setting fixing means, such as, for example, nails or bolts, in a substrate, it is known to use setting tools in which a plunger is pushed forwards in an abrupt or sudden movement, the plunger acting on the fixing means and driving or pushing it into the substrate. In order that the plunger is able to transmit an impulse sufficient to drive in the fixing means, on the one hand it must be accelerated to a high speed and on the other hand it must be provided with or connected to a large mass.

In order to achieve the high speed, various types of drive are known, for example explosion-type drives in which a propellant charge is ignited. Also known are tools in which a rotating flywheel is connected to the plunger via a coupling, as described, for example, in German Offenlegungsschrift DE 10 2009 021 727 A1.

With all types of drives it is necessary to move the plunger back into its starting position again in order then to be able to start a fresh setting operation. That backward movement can be realised with the aid of springs or, in the case of explosion-driven tools, also by diverting a portion of the drive gases, or in the case of semi-automatic tools also manually by hand.

A setting tool can also be referred to as a nail gun, pin driver tool, pin setting tool or generally as a device for driving in fixing means.

The problem of the invention is to define a drive solution for a setting tool which works reliably and allows continuous operation combined with high setting energy.

According to the invention the problem posed is solved by the setting tool of claim 1. Advantageous developments are defined in the dependent claims.

The invention is based on a setting tool having a drive apparatus in which a spring travel of a spring element is converted into a rapid, linear movement of a plunger via an intermediately arranged cord/rotary body kinematic system, it being possible to generate, for example, an impulse of more than 15 Ns at a translation ratio of 1:25. The translation is effected by first and second winding cords which are wound up and unwound on a rotary body and on the plunger. With the aid of such a drive apparatus in a setting tool it is possible for fixing means, such as bolts or nails, to be driven or pushed even into hard materials, such as, for example, into concrete.

The invention claims a setting tool for setting fixing means, especially nails, in a substrate, especially made of concrete, with a drive apparatus, having
a plunger, especially a rod-shaped plunger, which is movable in a longitudinal direction to drive in a fixing means,
a rotary body which is rotatable about a rotational axis,
at least one spring element,
first winding cords which connect the spring element and the rotary body and which are arranged and configured to convert a linear movement of the spring element into a rotational movement of the rotary body, and
second winding cords which connect the rotary body and the plunger and which are arranged and configured to convert a rotational movement of the rotary body about the rotational axis into a linear movement of the plunger in the longitudinal direction.

The invention offers the advantage that fixing means can be set securely, quickly and reliably with a minimum of effort.

The plunger can have one or more parts. The term “cords” also includes a single cord, that is to say a single first winding cord or a single second winding cord, although it is preferable, especially in the case of the first winding cords, to provide a plurality of cords in order to transmit the high forces symmetrically.

In a first preferred variant, the rotational axis of the rotary body is substantially parallel to the longitudinal direction in which the plunger is movable. In this variant the second winding cords are preferably configured to unwind or wind up the second winding cords on the plunger by a rotational movement of the rotary body, with the result that the linear movement of the plunger takes place. Preferably the plunger is arranged in the rotary body, resulting in a compact structure. “In the rotary body” does not mean that the plunger has to be arranged over its complete length inside an envelope volume defined by the rotary body, but simply means that it is at least in some regions enclosed by the rotary body.

In a second preferred variant, the rotational axis of the rotary body is substantially perpendicular to the longitudinal direction in which the plunger is movable. In other words, the rotary body is arranged so as to be rotatable perpendicularly to the axial direction of the plunger. In this variant the second winding cords are preferably configured to unwind or wind up the second winding cords on the rotary body by a rotational movement of the rotary body, with the result that the linear movement of the plunger in the axial direction takes place.

Preferably, in this second variant the spring element is arranged in the rotary body, thus resulting in a compact structure. “In the rotary body” does not mean that the spring element has to be arranged over its complete length inside an envelope volume defined by the rotary body, but simply means that it is at least in some regions enclosed by the rotary body.

In a development of the first or second variant, the rotary body can have an inner rotor and an outer rotor arranged concentrically rotatably thereon, the outer rotor being able to rotate with the inner rotor by means of, as driver device, a driver pin or driver projection of the inner rotor arranged to be movable in a slot, a groove or a recess of the outer rotor. The said driver device can also be arranged the other way round on the inner and outer rotors.

In a development of the first or second variant, the drive apparatus can have an electrical drive unit arranged outside the rotary body, which drive unit is configured to rotate the rotary body, with the result that the spring element is extended or compressed and accordingly pre-stressed.

In a development of the second variant, the drive arrangement has at least one return cord which connects the rotary body to the plunger and which returns the plunger from a setting position to a starting position, the return cord being wound up on the rotary body.

Preferably the spring element is compressible parallel to, especially coaxially with, the rotational axis. “Compressible” means compression of the spring element, but here also especially includes elongation.

Preferably the rotary body is arranged substantially rigidly along its rotational axis, with “rigidly” here relating to a single-part or multi-part housing and/or to the longitudinal axis of the plunger.

In a further embodiment, the rotary body can be connected to the spring element by means of the first winding cords in such a way that a spring force acts on the rotary body in both rotational directions of the rotary body, especially in such a way that a rotational movement of the rotary body brings about compression of the spring element, with the result that the drive apparatus is pre-stressed.

Preferably the rotary body is tubular. As a result it is possible to achieve a compact structure in which, for example, the plunger or the spring element is arranged in the rotary body. “Tubular” here also means annular, that is to say its extent along the rotational axis is substantially immaterial.

Preferably the spring element can be a gas spring. Such a spring is robust and reliable in operation.

In a development, the gas spring has a base plate and a top plate aligned parallel thereto.

In a further embodiment, the gas spring has at least one metal bellows which is fillable with gas and which is arranged between the top plate and the base plate, it especially being possible for the metal bellows to be encased by a carbon-fibre-reinforced plastics material.

In a further embodiment, the first winding cords are secured by one end in the top plate and by the other end to the rotary body.

In a further implementation, in a gas-filled state of the gas spring the pressure of the gas in the metal bellows is at least 50 bar.

In a further embodiment, the arrangement can have two gas springs arranged as mirror images of one another, it especially being possible for the base plates of the two gas springs to be located one on top of the other.

In a further embodiment, an equalisation bore passing through the base plates can be provided in order to equalise the gas pressure between the two gas springs.

In a development, the drive apparatus can have at least one holding diaphragm which supports the plunger and is arranged outside the rotary body, which holding diaphragm is configured to fix the plunger in position so as to be transversely and rotationally stable.

In a development, the drive apparatus can have at least one bearing element arranged outside the rotary body, which bearing element is configured to support the rotary body so as to be longitudinally and transversely stable.

In a development, the drive apparatus can have an electrical drive unit arranged outside the rotary body, which drive unit is configured to rotate the rotary body, with the result that the spring element is extended or compressed and accordingly pre-stressed.

In a development, the drive apparatus can have a gear unit arranged between the electrical drive unit and the rotary body, which gear unit is configured to translate the rotational movement of the electrical drive unit.

In a development, the drive apparatus can have a coupling unit arranged between the gear unit and the rotary body, which coupling unit is configured to activate a linear movement of the plunger.

In order to hold the drive apparatus securely against a torque applied by the spring element and against unintentional triggering, the invention proposes a trigger device, having
a first crown wheel having first teeth, which is in force-based connection with the rotary body,
a non-rotatable second crown wheel which is complementary to the first crown wheel and is movable relative to the first crown wheel along the crown wheel axis and the second teeth of which can be brought into force-based engagement with the first teeth in such a way that the rotary body is fixed against rotational movement up to a maximum torque, and
an unlocking means which is configured to move the second crown wheel out of engagement with the first crown wheel.

A crown wheel is by definition a toothed wheel, the toothing of which has been provided on the end face of a circular cone or circular cylinder. It is usually used for transmitting rotational movements between shafts that are located at an angle to one another. The crown wheels can each have one or more toothed rims.

“Non-rotatable” means here that the second crown wheel is either fixed to the housing or rigidly connected to a drive.

In a development, the tooth flanks of the first and second teeth can be inclined with respect to the crown wheel axis. As a result, the required static friction on engagement is ensured.

In a further embodiment, the second crown wheel can be formed partly from a ferro-magnetic material.

In a further embodiment, the unlocking means can have at least one electromagnet, which is configured to release or move the second crown wheel out of engagement with the first crown wheel when current flows through the electromagnet.

Preferably the setting tool has a single-part or multi-part housing in which the drive apparatus is arranged.

In a further embodiment, the setting tool has a trigger button which is configured to activate a setting operation by controlling the electrical drive unit and/or the coupling unit.

In a development, the setting tool has a setting opening in the housing, through which opening a fixing means is arranged to be driven out.

In a further embodiment, the setting tool has a handle portion in the housing, which handle portion is configured so that the setting tool can be held by a user.

Further features and advantages of the invention will become apparent from the following explanations of two exemplary embodiments with reference to diagrammatic drawings, wherein

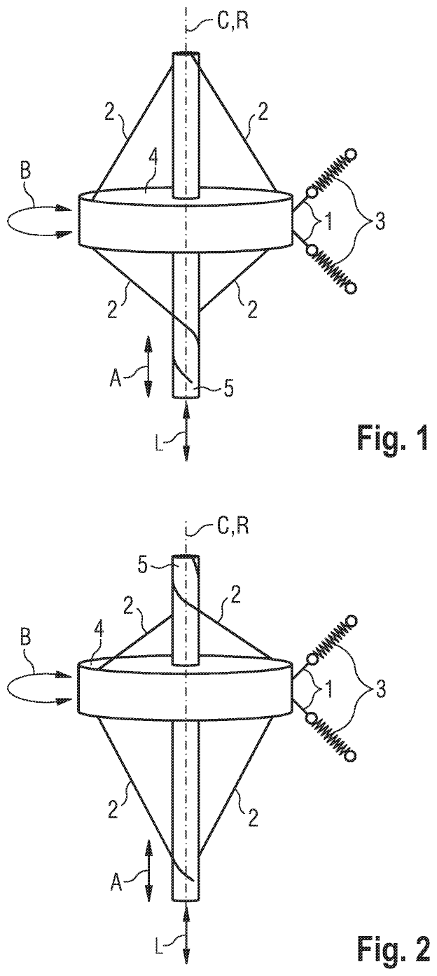

FIG. 1: is a three-dimensional view of the drive apparatus of a first exemplary embodiment in a starting position,

FIG. 2: is a three-dimensional view of the drive apparatus in a setting position,

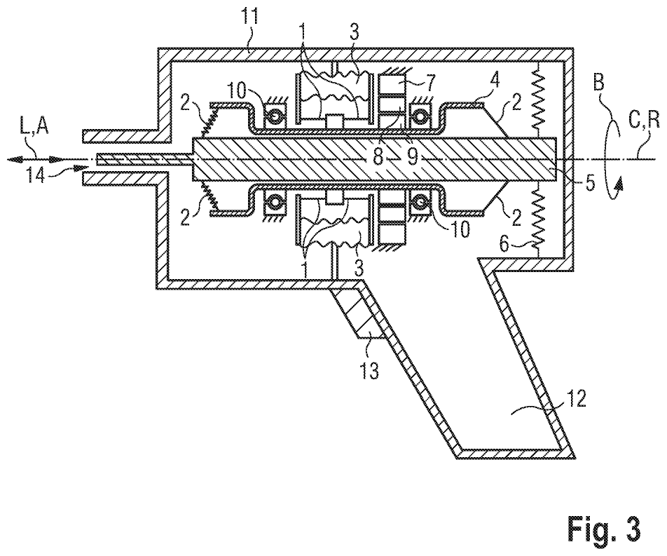

FIG. 3: shows a cross-section through a setting tool with a drive apparatus,

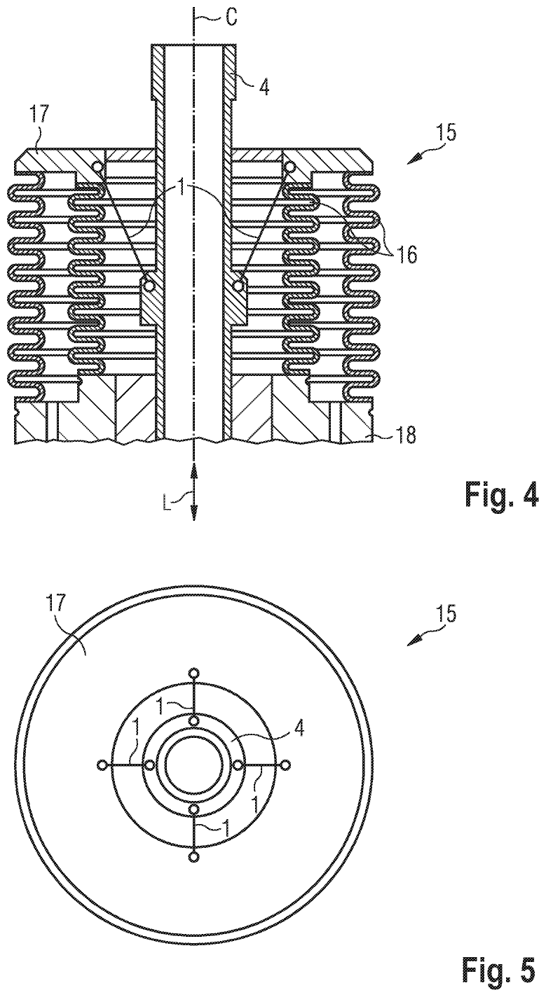

FIG. 4: is a sectional view through a gas spring as spring element arranged on the rotary body of the drive apparatus,

FIG. 5: is a plan view onto a gas spring arranged on a rotary body,

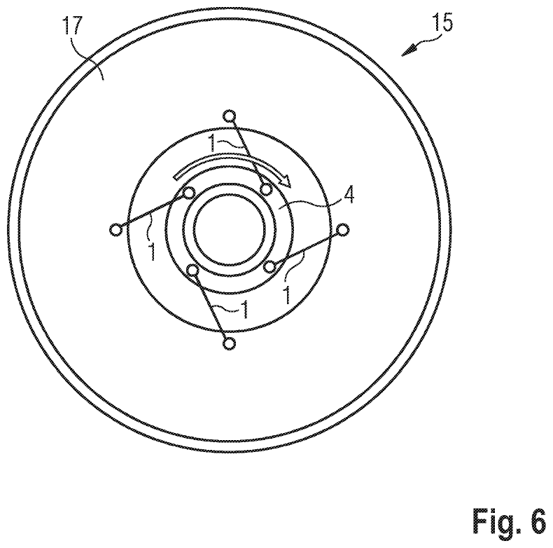

FIG. 6: is a plan view onto a gas spring arranged on a rotary body, with a rotary body twisted through 45 degrees,

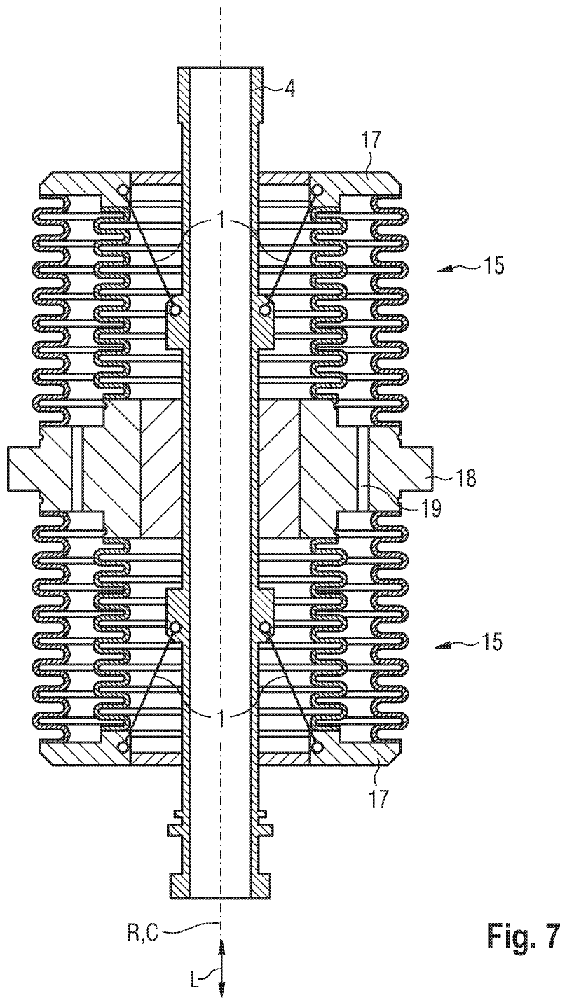

FIG. 7: is a sectional view through two gas springs arranged symmetrically on a rotary body,

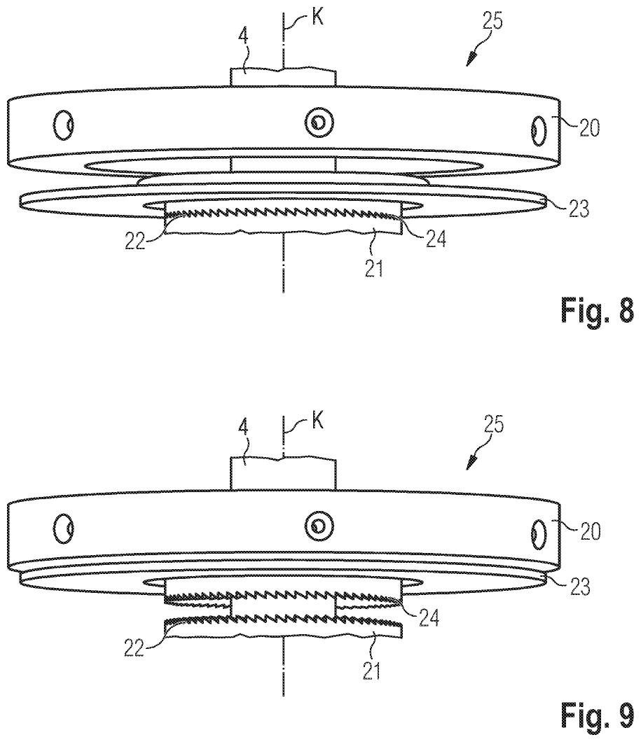

FIG. 8: is a three-dimensional view of a trigger device of the drive apparatus in a locked position,

FIG. 9: is a three-dimensional view of the same trigger device in a trigger position,

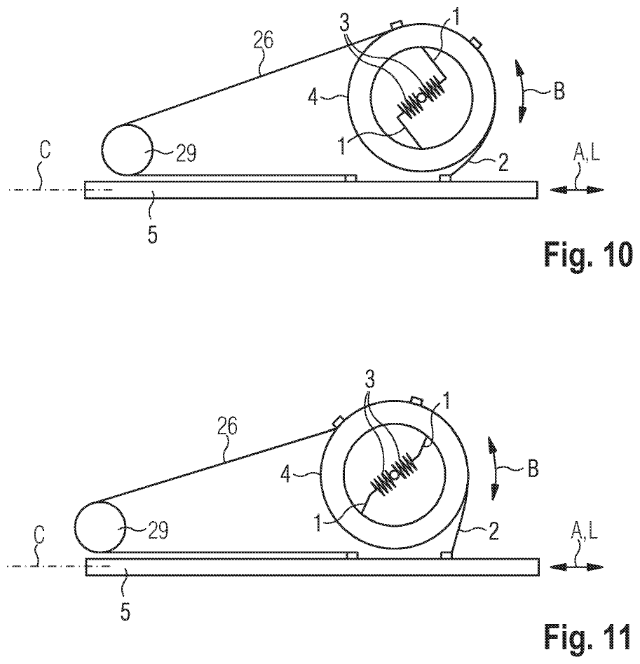

FIG. 10: is a side view of the drive apparatus of a second exemplary embodiment in a starting position,

FIG. 11: is a side view of the drive apparatus in a setting position,

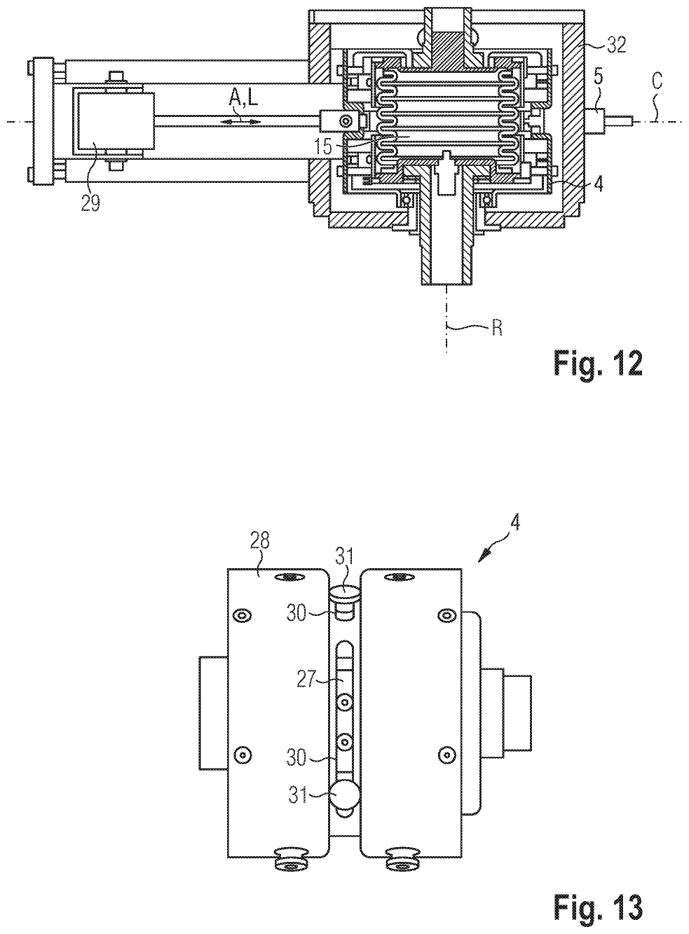

FIG. 12: is a sectional view of the drive apparatus with a gas spring as spring element,

FIG. 13: is a side view of a two-part rotary body, and

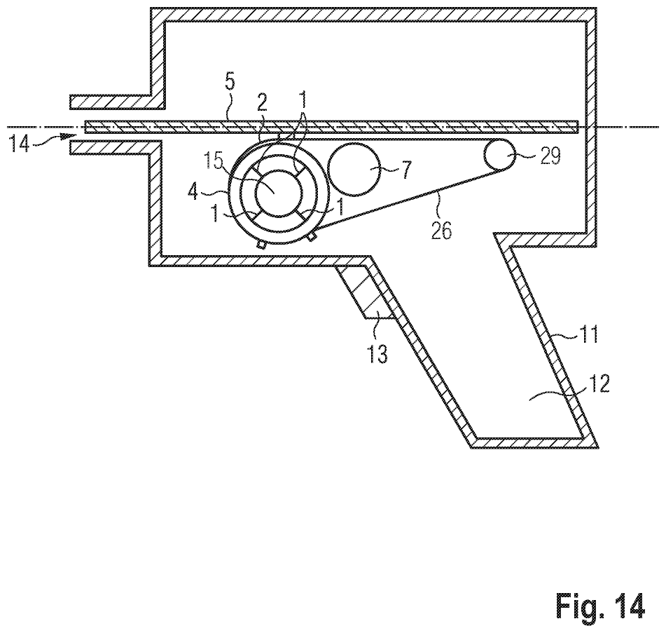

FIG. 14: is a cross-section through a setting tool with a drive apparatus.

### DETAILED DESCRIPTION OF THE FIRST EXEMPLARY EMBODIMENT

As part of the setting tool of the first exemplary embodiment, FIG. 1 and FIG. 2 each show a three-dimensional view of the drive apparatus, in a starting position (FIG. 1) and in a setting position (FIG. 2). The drive apparatus has a single-part or multi-part plunger 5, with one end of which a fixing means (not shown) is arranged to be driven directly or indirectly into a substrate (not shown). To generate the necessary impulse, a cord/rotary reciprocator kinematic system is used, consisting of a tubular rotary body 4, the second winding cords 2, the spring elements 3 and the first winding cords 1.

The plunger 5 is movable linearly, that is to say translationally, the plunger being guided along its longitudinal axis C, that is to say in a longitudinal direction L, but cannot be twisted. The tubular rotary body 4 is concentrically rotatably mounted over the plunger 5, that is to say the rotary body 4 is able to rotate relative to the plunger 5. The rotational axis R is parallel to the longitudinal direction L. For that purpose the rotary body 4 is hollow and the rod-shaped plunger 5 passes through it. The plunger 5 is therefore arranged in the rotary body 4. The rotary body 4 is mounted axially in such a way (not shown) that rotation of the rotary body 4 is as far as possible frictionless and low-loss and the rotary body is arranged rigidly along the rotational axis R.

The first winding cords 1 connect the spring elements 3 to the rotary body 4, so that on rotation of the rotary body 4 the spring elements 3 are tensioned, with the winding cords 1 winding at least partly around the rotary body 4 and assuming a slanted position with respect to the rotary body 4. The rotary body 4 is connected to the first winding cords 1 in such a way that a spring force acts on the rotary body 4 in both rotational directions of the rotary body 4.

The second winding cords 2 connect the rotary body 4 to the plunger 5; by rotation of the rotary body 4 in rotational direction B about the rotational axis R the second winding cords 2 wrap around the plunger 5 and, as a result of the “apparent shortening of the cord” that thereby takes place, cause it to perform a linear movement in direction A, that is to say in the longitudinal direction L.

By rotation of the rotary body 4, the rotary reciprocator is pre-stressed, the spring elements 3 are tensioned or compressed via the first winding cords 1 and accordingly store energy which, when the rotary body 4 is let go, is abruptly transformed into a rotational movement of the rotary body 4 and accordingly into a linear movement of the plunger 5.

By the selection of the diameters of the rotary body 4 and the plunger 5 it is possible to set the translation ratio which converts the spring travel of the spring elements 3 into a stroke of the plunger 5.

FIG. 3 shows, in extremely simplified form, the setting tool of the first exemplary embodiment with a drive apparatus according to FIG. 1 and FIG. 2 in a housing 11. The housing 11 has a front end in which there is arranged a setting opening 14 for a fixing means to be set, such as a bolt or nail. The housing 11 has a handle portion 12 by which a user can grasp and hold the setting tool. At the upper end of the handle portion 12 there is arranged a trigger button 13 with the aid of which the user can trigger and therefore perform a setting operation. A rechargeable battery, a disposable battery or a mains adapter can be mounted in the handle portion 12 for supplying power to the setting tool.

The drive apparatus has the plunger 5 which drives a fixing means (not shown) out through the setting opening 14. The linear, abrupt movement of the plunger 5 is effected by the kinematic system described in FIG. 1 and FIG. 2, wherein a pre-stressed spring element 3 converts its energy via the first winding cords 1 into a rotational movement in rotational direction B of the tubular rotary body 4 which, in turn, converts its rotational movement B via the second winding cords 2 into the linear movement in direction A of the plunger 5. As a result, a small spring travel can be abruptly converted into a large linear movement of the plunger 5. The rotary body 4 is rotatably mounted in the support elements 10, but is not displaceable in the longitudinal direction. As a result, the rotary body 4 is arranged rigidly with respect to the housing 11 along the rotational axis R.

The plunger 5 needs to be securely mounted against twisting. For that purpose there is used a torsion-resistant and transversely rigid holding diaphragm 6 at the end of the plunger 5 remote from the setting opening 14, but alternatively also at the other end. This ensures that the plunger 5 converts the rotational movement of the rotary body 4 exclusively into a linear movement.

For “charging” or “winding up” the setting tool there is used the electrical drive unit 7 which, via a gear unit 8 and a coupling unit 9, sets the rotary body 4 in rotation and thereby pre-stresses the spring elements 3. By means of the coupling unit 9 the rotary body 4 can also be held in a tensioned position which is released by the trigger button 13. Alternatively the electrical drive unit 7 can be switched off at the maximum charge state and the setting operation can thereby be triggered without the spring tension being maintained in the interim.

As a result of the selected translation ratio and as a result of the kinematic system of the second winding cords 2, the rotary body 4 needs only to be able to perform a rotational movement through approximately +/−45 degrees in order to set fixing means.

Gas springs 15 are used as spring elements 3. FIG. 4 shows a cross-section through a gas spring 15, which consists of two concentrically arranged metal bellows 16 which, closed by a common base plate 18 and a top plate 17, form a hermetically sealed container for a gas. The container can be filled with gas through a valve (not shown) mounted in the top plate 17. The effective radii of the two metal bellows 16 are such that, for example, at a gas pressure of 50 bar a force on the base and top plates 17, 18 of about 20 kN is produced.

The rotary body 4 of the cord/rotary reciprocator kinematic system as shown in FIG. 1 and FIG. 2 is arranged running concentrically through the gas spring 15. First winding cords 1, which transmit the pre-stressing force to the cord/rotary reciprocator kinematic system, are mounted by one end on the top plate 17 of the gas spring 15, and by the other end on the rotary body 4. In the unpressurised state of the gas spring 15 the first winding cords 1 are installed in such a way that, after mounting, they are in a taut and slightly pre-stressed state. After being mounted in the top plate 17 of the gas spring 15 and in the rotary body 4 of the cord/rotary reciprocator kinematic system, in a plan view onto the top plate 17 the first winding cords 1 are radially aligned, as can be seen in FIG. 5.

In respect of the description of FIG. 5 and FIG. 6 it should mentioned once again that, by means of a suitable bearing, the rotary body 4 is prevented from moving in the direction of the longitudinal axis C. Rather, the rotary body 4 is able to perform only a rotation about the longitudinal axis C which is concentric with the rotational axis R. When the gas 15 is filled with gas, pressure builds up which acts on the top plate 17 in the direction of the longitudinal axis C and accordingly exerts a tensile force on the first winding cords 1.

When, by means of an appropriate means (not shown, for example a motor), the rotary body 4 is rotated through a predefinable angle out of its original position, as shown in FIG. 6, the pressurised gas spring 15 generates a force on the first winding cords 1 which generate a torque at the mounting points of the first winding cords 1, which torque corresponds to the tangential component of the force transmitted by the first winding cords 1 to the rotary body 4, multiplied by the radius of the mounting point on the rotary body 4. With the second winding cords 2, the plunger 5 located in the interior of the rotary body 4 can be caused to perform a longitudinal movement in accordance with FIG. 1 and FIG. 2.

An exemplary arrangement at a pressure of 50 bar delivers an initial torque of 300 Nm when the rotary body 4 is twisted through 45 degrees about the longitudinal axis C, which torque acts on the cord/rotary reciprocator kinematic system via the rotary body 4. Since the length of the cord does not change in dynamic operation, the twisting causes the top plate 17 to be pulled downwards in the direction of the base plate 18 (FIG. 4) and accordingly the gas spring 15 is compressed. This results in a slight modulation of the gas pressure as a result of the reciprocating motion of the rotary body 4.

In the arrangement in accordance with FIG. 4, a bearing for suppressing a movement of the rotary body 4 in the axial direction would be acted upon by a resultant, substantial force as soon as the gas spring 15 is inflated to its nominal pressure. In the example, the nominal pressure is 50 bar, giving rise to a force on the bearing (not shown) of about 20 kN in the case of the specified geometry of the gas spring 15.

Such a bearing subjected to high forces can be entirely avoided if a symmetrical arrangement is realised, as shown in FIG. 7. As can be seen from the drawing, there are two gas springs 15, the forces of which act in opposite directions on pressurisation, as well as two symmetrical arrangements of first winding cords 1, which are referred to hereinbelow as the “lower and upper winding cord arrangements”. If the two gas springs 15 have the same dimensions and the gas pressures are the same, the forces which the two gas springs 15 exert on the respective top plates 17 via the first winding cords 1 on the rotary body 4, are opposite and equal and therefore cancel each other out. A bearing for compensating axial forces is therefore no longer required. In contrast, the torques of the lower and upper winding cord arrangements act in the same direction, that is to say they are added together.

In order to equalise the pressures in the two gas spring 15, an equalisation bore 19 can optionally be provided, through which pressure equalisation takes place. To suppress pressure oscillations between the two gas springs 15, the equalisation bore 19 can have a flow throttle (not shown).

The number of first winding cords 1, as shown in FIG. 5 and FIG. 6, need not necessarily be four. For reasons of stability against buckling of the metal bellows 16, however, at least three first winding cords 1 should be used for each gas spring 15 at angular spacings of 120°. Otherwise—of course bearing in mind a sensible design—any number n of cords can be used, the angular spacing of which from one another is given by: φ=360°/n.

To suppress longitudinal or flexural oscillations of the metal bellows 16, the latter can be surrounded by a carbon-fibre-reinforced plastics casing. By virtue of the properties of the fibre/synthetic resin potting composition, oscillations are damped. Moreover, this can provide protection against the high dynamic loads which arise in the material of the metal bellows 16 during the extremely short switching times of the cord/rotary reciprocator kinematic system.

The gas spring 15, which is composed of metal bellows 16, has a significant advantage over other springs. The pressure of the gas in the gas spring 15 formed by the metal bellows 16, the base plate 18 and the top plate 17 obeys the known relationship for ideal gases:

p*V=const., (1)

where p is the pressure and V is the volume.

As, for example, simulation calculations and experiments have shown, oscillations of the metal bellows 16 have no appreciable effect on the volume V of the metal bellows 16 of the gas springs 15 and accordingly also have no effect on the pressure as a cause of the torque acting on the rotary body 4 via the first winding cords 1. Accordingly, disruptions caused by unavoidable resonances are effectively decoupled.

A further advantage results from the concentric arrangement of the gas springs 15 around the rotary body 4. This allows this central drive unit to have a compact structure.

For fixing the rotary body 4 against rotation in the tensioned state against a maximum torque applied by the spring elements 3, a trigger device 20 is used as coupling unit 9 according to FIG. 8 and FIG. 9.

FIG. 8 and FIG. 9 show a three-dimensional view of the trigger device 20 which is used for fixing (FIG. 8) against rotation and for triggering (FIG. 9) a rotational movement of the rotary body 4. For that purpose, the trigger device 20 has a first crown wheel 21 which is rigidly connected by its end face to the rotary body 4 and the first teeth 22 of which are sloping at least on one side, that is to say the tooth flanks are inclined with respect to the crown wheel axis K. The crown wheel axis K coincides with the rotational axis R of the rotary body 4. The first crown wheel 21 can alternatively also be arranged at a location on the curved wall surface of the rotary body 4.

For fixing the first crown wheel 21 in position there is used the non-rotatable second crown wheel 23 which is arranged as a mirror image and the second teeth 24 of which are able to engage the first teeth 22 in such a way that the first crown wheel 21 is secured against rotation. By suitable selection of the slope of the tooth flanks it is ensured that, by means of static friction between the sloping tooth flanks, a sufficiently large counter-force is applied against the tangential force component acting through the torque, so that the second crown wheel 23 does not independently slip out of engagement. The crown wheels 21, 23 are preferably made of steel.

For releasing the engagement there is used the unlocking means 25, which is preferably in the form of an electromagnet and, when current flows through the coil or coils of the electromagnet, exerts a force in the direction of the crown wheel axis K and in the direction of the unlocking means 25, which force pulls the second crown wheel 23 out of engagement with the first crown wheel 21 against the static friction or kinetic friction. As a result, a rotational movement of the first crown wheel 21 and accordingly of the rotary body 4 is enabled. If the electromagnet is appropriately dimensioned and arranged, such triggering can take place abruptly and in a very short time (a few milliseconds).

The second crown wheel 23 can be returned to engagement with the first crown wheel 21 by means of any desired actuating means (not shown).

### DETAILED DESCRIPTION OF THE SECOND EXEMPLARY EMBODIMENT

As part of the setting tool of the second exemplary embodiment, FIG. 10 and FIG. 11 each show a side view of the drive apparatus, in a starting position (FIG. 10) and in a setting position (FIG. 11). In the case of corresponding components, the names and reference numerals used for the second exemplary embodiment are the same as those used for the first exemplary embodiment.

The drive apparatus has a single-part or multi-part plunger 5, with one end of which a fixing means (not shown) is arranged to be driven directly or indirectly into a substrate (likewise not shown). To generate the necessary impulse, a cord/rotary reciprocator kinematic system is used consisting of a tubular rotary body 4, a second winding cord 2, a spring element 3 and first winding cords 1.

The plunger 5 is movable linearly, that is to say translationally, in linear movement direction A, the plunger 5 being guided along its longitudinal axis C in a longitudinal direction L. Above the plunger 5, the tubular rotary body 4 is mounted so as to be rotatable around the rotational direction B, the rotational axis R of the rotary body 4 (see also FIG. 12) being aligned perpendicularly to the linear movement direction A, that is to say also perpendicular to the longitudinal direction L. The rotary body 4 is hollow and mounted in such a way (not shown) that rotation of the rotary body 4 is as far as possible frictionless and low-loss.

The first winding cords 1 connect the spring elements 3 arranged in the interior of the rotary body 4 to the rotary body 4, so that on rotation of the rotary body 4 the spring elements 3 are tensioned, with the first winding cords 1 changing their angle, that is to say assuming a slanted position, with respect to the rotary body 4.

By rotation of the rotary body 4, the second winding cord 2 is wound up on the rotary body 4. The second winding cord 2 connects the outer side of the rotary body 4 to the plunger 5; by rotation of the rotary body 4 in rotational direction B the second winding cord 2 moves the plunger 5 along the linear movement direction A. As a result of this “apparent shortening of the cord”, the rotational movement of the rotary body 4 in rotational direction B causes the plunger 5 to perform an axial movement along the linear movement direction A.

By rotation of the rotary body 4, the cord/rotary body kinematic system is pre-stressed, the spring elements 3 are tensioned via the first winding cords 1 and accordingly store energy which, when the rotary body 4 is “let go”, is abruptly transformed into a rotational movement of the rotary body 4 and accordingly into a linear movement of the plunger 5.

By the selection of the internal diameter of the rotary body 4 and the position of the suspension points of the first and second winding cords 1, 2 it is possible to set the translation ratio which converts the spring travel of the spring elements 3 into a stroke of the plunger 5. The plunger 5 can be returned to its starting position with the aid of a return cord 26. The return cord 26 is secured to the outside of the rotary body 4 and by its other end to the plunger 5. With the aid of a pulley 29, the return cord 26 is diverted into the axial direction A.

Alternatively the function of the return cord 26 could be exchanged with the second winding cord 2. In that case the abrupt movement of the plunger 5 would take place in the reverse direction (to the left in FIG. 10), that is to say FIG. 10 would show the setting position.

FIG. 12 shows a sectional view of the drive apparatus having a gas spring 15 as spring element 3. For reasons of clarity in the drawing, the first and second winding cords 1, 2 are not shown. Seated in the interior of the rotary body 4 there is a gas spring 15 which can be compressed by means of the first winding cords 1 on rotation of the rotary body 4. The first winding cords 1 are connected to the end faces of the gas spring 15 and the inner side of the rotary body 4. The Figure shows the plunger 5 as well as the pulley 29 for the return cord 26 (not shown). The rotary body 4 together with the gas spring 15 is located in a receiving housing 32.

In respect of the structure, including the symmetrical arrangement of two gas springs 15, and the mode of operation, reference is made to the remarks relating to the first exemplary embodiment.

When the gas spring 15 is relieved of tension—as described in connection with FIG. 10 and FIG. 11—with the aid of the second winding cord 2 the plunger 5 is moved translationally by rotation of the rotary body 4.

FIG. 13 shows the tubular rotary body 4 implemented in two-part form, wherein an inner rotor 27 is mounted concentrically in an outer rotor 28 so that they are twistable relative to one another. In order that the outer rotor 28 is able to rotate with the inner rotor 27 and vice versa, a slot 30 is formed as driver device in the outer rotor 28 on the curved wall face. A driver pin 31 arranged on the inner rotor 27 engages in the slot 30 and, on striking a stop, is able to “entrain” the outer rotor 28. Alternatively, instead of a slot 30 on the curved wall face it would also be possible, for example, to provide a groove on an end face, into which groove a driver projection arranged on the inner rotor 27 engages (not shown) instead of the driver pin 31. It would also be possible for the driver device to be arranged the other way round on the inner and outer rotors 27, 28 (not shown).

By virtue of such a design, for example the outer rotor 28 can, as a result of its inertia, rotate independently of the inner rotor 27 in accordance with the length of the slot 30 until the driver pin 31 strikes the other end of the slot 30. Accordingly, the impulse of a plunger 5 connected to the outer rotor 28 via the second winding cord 2 can decline continuously. On reaching the stop, the outer rotor 28 is braked again by the spring element 3 (not shown in FIG. 13). As a result, surplus energy not consumed by the setting operation can be absorbed by the spring element 3. This is necessary especially in the absence of a fixing means to be driven in.

FIG. 14 shows, in extremely simplified form, a setting tool having a drive apparatus according to FIG. 10 to FIG. 13 in a housing 11. The housing 11 has a front end in which there is arranged a setting opening 14 for a fixing means to be set, such as a bolt or nail (not shown). The housing 11 has a handle portion 12 by which a user can grasp and hold the setting tool. At the upper end of the handle portion 12 there is arranged a trigger button 13 with the aid of which the user can trigger and therefore perform a setting operation. A rechargeable battery, a disposable battery or a mains adapter can be mounted in the handle portion 12.

The drive apparatus has the plunger 5 which drives a fixing means (not shown) out through the setting opening 14. The linear, abrupt movement of the plunger 5 is effected by the kinematic system described in FIG. 10 to FIG. 13, wherein a pre-stressed gas spring 15 converts its energy via the first winding cords 1 into a rotational movement in direction B of the rotary body 4 which, in turn, converts its rotational movement in direction B via the second winding cord 2 into the linear movement in direction A of the plunger 5. As a result, a small spring travel can be abruptly converted into a large linear movement of the plunger 5. The plunger 5 can be returned to its starting position again with the aid of the return cord 26.

For “charging” or “winding up” the setting tool there is used the electrical drive unit 7 which sets the rotary body 4 in rotation and thereby pre-stresses the gas spring 15 with the aid of the first winding cords 1. By means of the trigger button 13, a setting operation is enabled in that the electrical drive unit 7 is switched on, the rotary body 4 is set in rotation and the electrical drive unit 7 is switched off at a maximum charge state, with the result that the setting operation can be triggered without the spring tension being maintained in the interim.

This is preferably effected by a coupling element, such as the coupling unit 9 described in connection with the first exemplary embodiment, which releases the interlocking or force-based connection between the rotary body 4 and the drive unit 7 when the charge state is reached. This can be, for example, a meshing arrangement which closes the meshing partners via a spring and, when the rotary body 4 reaches a predefinable angle 4, opens the meshing arrangement via a shaped element (for example a spring), as has been explained with reference to the first exemplary embodiment.

As a result of the selected translation ratio and as a result of the kinematic system of the first winding cords 1 and the second winding cord 2, the rotary body 4 needs only to be able to perform a rotational movement through approximately +/−45 degrees in order to set fixing means. In the embodiment having an inner and an outer rotor 27, 28 (FIG. 13), for acceleration the inner rotor 27 is rotated, for example, through only 20 degrees, the remaining 50 degrees of the outer rotor 28 being purely ballistic (slot 30!), and at 70 degrees the outer rotor 28 travels together with the inner rotor 27 into the spring element 3 again and is thus braked.

Although the invention has been illustrated and described in detail by means of the exemplary embodiments, the invention is not limited by the examples disclosed, and the person skilled in the art can derive other variations therefrom without departing from the scope of protection of the invention.

### LIST OF REFERENCE SYMBOLS

### Setting Tool

1 first winding cord
2 second winding cord
3 spring element
4 rotary body
5 plunger
6 holding diaphragm
7 electrical drive unit
8 gear unit
9 coupling unit
10 bearing element
11 housing
12 handle portion
13 trigger button
14 setting opening
15 gas spring
16 metal bellows
17 top plate
18 base plate
19 equalisation bore
20 trigger device
21 first crown wheel
22 first teeth
23 second crown wheel
24 second teeth
25 unlocking means
26 return cord
27 inner rotor
28 outer rotor
29 pulley
30 slot
31 driver pin
32 receiving housing
A linear movement direction
B rotational direction
C longitudinal axis of the plunger 5
K crown wheel axis
L longitudinal direction
R rotational axis

1. A setting tool for setting a fixing means in a substrate with a drive apparatus,
comprising:
a plunger which is movable in a longitudinal direction to drive in the fixing means,
a rotary body which is rotatable about a rotational axis,
at least one spring element,
first winding cords which connect the spring element and the rotary body and which are arranged and configured to convert a linear movement of the spring element into a rotational movement of the rotary body, and
second winding cords which connect the rotary body and the plunger and which are arranged and configured to convert a rotational movement of the rotary body about the rotational axis into a linear movement of the plunger in the longitudinal direction.

2. The setting tool according to claim 1, wherein the rotational axis is substantially parallel to the longitudinal direction.

3. The setting tool according to claim 2, wherein the plunger is arranged in the rotary body.

4. The setting tool according to claim 1, wherein the rotational axis is substantially perpendicular to the longitudinal direction.

5. The setting tool according to claim 4, wherein the spring element is arranged in the rotary body.

6. The setting tool according to claim 1, wherein the spring element is compressible parallel to the rotational axis.

7. The setting tool according to claim 1, wherein the rotary body is arranged substantially rigidly along the rotational axis.

8. The setting tool according to claim 1, wherein the second winding cords are configured to unwind or wind up the second winding cords on the plunger or on the rotary body by a rotational movement of the rotary body, with the result that the linear movement of the plunger takes place.

9. The setting tool according to claim 1, wherein the rotary body is connected to the spring element by means of the first winding cords in such a way that a spring force acts on the rotary body in both rotational directions of the rotary body, with the result that the drive apparatus is pre-stressed.

10. The setting tool according to claim 1, wherein the rotary body is tubular.

11. The setting tool according to claim 1, wherein the spring element has a gas spring.

12. The setting tool according to claim 11, wherein the gas spring has a base plate and a top plate aligned parallel thereto, as well as a bellows arranged between the top plate and the base plate.

13. The setting tool according to claim 11, wherein the drive apparatus has two gas springs arranged as mirror images of one another, the base plates of the two gas springs are located one on top of the other, and an equalisation bore passing through the base plates is provided in order to equalise the gas pressure between the two gas springs.

14. The setting tool according to claim 1, including
at least one holding diaphragm which supports the plunger and is arranged outside the rotary body, which holding diaphragm is configured to fix the plunger in position so as to be transversely and rotationally stable.

15. The setting tool according to claim 1, including
at least one bearing element arranged outside the rotary body, which bearing element is configured to support the rotary body so as to be longitudinally and transversely stable.

16. The setting tool according to claim 1, including
an electrical drive unit arranged outside the rotary body, which drive unit is configured to rotate the rotary body, with the result that the spring element is extended or compressed.

17. The setting tool according to claim 1, including
a gear unit arranged between the electrical drive unit and the rotary body, which gear unit is configured to translate the rotational movement of the electrical drive unit.

18. The setting tool according to claim 1, including
coupling unit arranged between the gear unit and the rotary body, which coupling unit is configured to activate a linear movement of the plunger.

19. The setting tool according to claim 1, wherein the drive apparatus comprises a trigger device for holding the rotary body against a torque applied by the spring element, having:
a first crown wheel having first teeth, which is in force-based connection with the rotary body,
a non-rotatable second crown wheel which is complementary to the first crown wheel and is movable relative to the first crown wheel along the crown wheel axis and the second teeth of which can be brought into force-based engagement with the first teeth in such a way that the rotary body is fixed against rotational movement up to a maximum torque, and
an unlocking means which is configured to move the second crown wheel out of engagement with the first crown wheel.

20. The setting tool according to claim 1, wherein the plunger is a rod-shaped plunger.
